(19) United States
(12) Patent Application Publication
(10) Pub. No.: US 2010/0104780 A1
(43) Pub. Date: Apr. 29, 2010

(54) PRINTED EL FOIL FOR BACKLIT AIRBAG EMBLEM

(76) Inventors: Donald J. Paxton, Romeo, MI (US); Henry Vernon Phillips, Shelby Township, MI (US)

Correspondence Address: AUTOLIV ASP INC, 3350 AIRPORT ROAD, OGDEN, UT, 84405, US

(21) Appl. No.: 12/363,372

(22) Filed: Jan. 30, 2009

Related U.S. Application Data
(63) Continuation-in-part of application No. 12/290,105, filed on Oct. 27, 2008.

(51) Int. Cl. B60R 13/00; B32B 37/00

(52) U.S. Cl. 428/31; 156/60

(57) ABSTRACT

A backlit (illuminated) emblem is used as part of an airbag cover to increase the visual appeal of the emblem. The emblem may represent the logo or trademark of the vehicle manufacturer. The emblem will generally include one or more windows which are openings or transparent/translucent areas. The emblem is backlit using EL foil. However, the EL foil will include one or more areas of opaque colors that correspond to the position of the windows on the emblem. More specifically, for the areas of the emblem that require opaque colors, the colors are not added to the emblem, but rather, this opaque color will be added to the EL foil and is visible through the windows in the emblem.

### CROSS-REFERENCED RELATED APPLICATIONS

This application is a continuation-in-part of prior U.S. patent application No. 12/290,105 filed on Oct. 27, 2008. This prior patent application is expressly incorporated herein by reference.

### BACKGROUND OF THE INVENTION

Airbag systems are commonly used on vehicles and especially in steering wheels. These airbags are designed to inflate during an accident to prevent the occupant from harmful impact with the steering wheel during a crash. Accordingly, the airbag system will generally be positioned in the steering wheel.

It is also known that most vehicle manufacturers want to have their logo or trademark on the steering wheel. These logos or trademarks are often colored images and are positioned on the steering wheel (such as on the cover of the steering wheel that is used to cover the airbag system). Some logos may also have a metallic chrome portion for improved appearance. Such positioning of the logo fosters brand recognition and also helps the vehicle occupant to remember that cars made by the vehicle manufacturer have airbags and are thus safer.

In order to further make the company's logo “stand out,” some parties have even begun to seek for ways to illuminate the logo/trademark. One example of this type of system is found in International Patent Publication No. WO 2007/084031, which document is expressly incorporated herein by this reference.

### BRIEF SUMMARY OF THE INVENTION

The present embodiments relate to a backlit (illuminated) emblem that is used as part of an airbag cover to increase the visual appeal of the emblem. The emblem will generally include one or more windows which are openings or transparent or translucent areas. The emblem may be made of chrome or other materials.

The emblem will be backlit using EL foil. However, the EL foil will include one or more areas of opaque colors that will correspond to the position of the windows on the emblem. In other words, for the areas of the emblem that require opaque colors, the colors will not be added to the emblem, but rather, this opaque color will be added to the EL foil. The consumer will, of course, still see these opaque colors because of the windows in the emblem.

By placing the opaque colors on the EL foil rather than on the emblem, significant advantages may be achieved. Previously, the opaque colors on the emblem were often difficult to make visually appealing because the light from the backlighting source would “bleed” through the opaque color. Accordingly, many coats of paint were required to achieve an opaque color on the emblem. However, by placing the opaque color on the EL foil, this problem is obviated.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of the rear side of a steering wheel cover according to the present embodiments;

FIG. 2 is an assembly view of the steering wheel cover of FIG. 1;

FIG. 3 is a perspective view of the front side of the steering wheel cover of FIG. 1, the cover being fully assembled; and

FIG. 4 is an assembly view of another embodiment of an emblem that may be used in the present embodiments.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

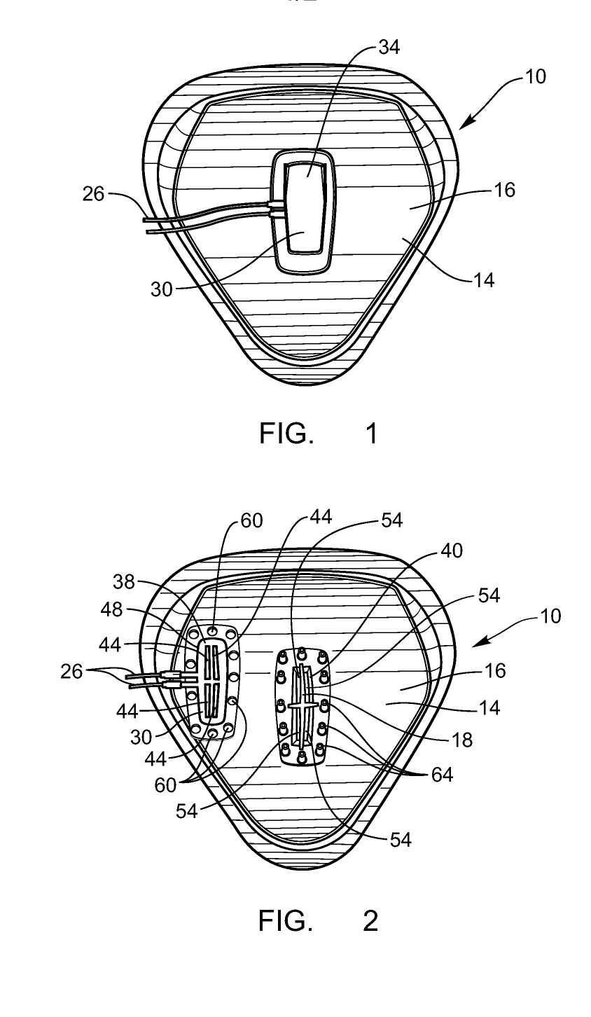

Referring now to FIG. 1, an example of an airbag apparatus 10 according to the present embodiments is shown. The airbag apparatus 10 is part of an airbag module that includes on an airbag cover 14. As known in the art, the cover 14 will be positioned as part of the steering wheel (or at other portions of the vehicle) and will have a front surface (not shown in FIG. 1) that has a visually appealing appearance. The rear surface 16 of the cover 14 is visible in FIG. 1. During an accident or crash, an airbag will deploy through the cover 14 into the vehicle interior.

Specifically, as noted above, it is often desirable to place an emblem 18 (shown in FIG. 2) of the vehicle manufacturer on the airbag cover 14. (The emblem may be any trademark, symbol, or logo of the vehicle manufacturer.)

In some embodiments, it may be desirable to illuminate the emblem 18 in order to give it more visual appeal. Accordingly, one or more wires 26 may be attached to EL foil 30 (not shown in FIG. 1) to provide illumination to the emblem 18. Of course, the wires 26 will be positioned behind the cover 14, dashboard or other class A surfaces of the vehicle such that they are not visible to the vehicle occupant.

FIG. 1 shows the rearward side 16 of the cover 14 (i.e., the side of the cover 14 that will be hidden from the occupant when the apparatus 10 and the cover 14 are installed on the vehicle). FIG. 2 also shows the EL foil 30 that is connected to the wires 26. The EL foil 30 is positioned directly rearward of the emblem 18 (not shown in FIG. 1). The EL foil 30 provides illumination/light such that the emblem 18 becomes illuminated and lighted to the vehicle occupant's eye. The rear side 34 of the EL foil 30 is shown in FIG. 1.

FIG. 2 is an assembly view that shows how the apparatus 10 may be constructed. In FIG. 2, the front side 38 of the EL foil 30 is shown for clarity. Of course, when the EL foil 30 is installed, it will be installed as indicated in FIG. 1 in which the front face 38 of the EL foil 30 is adjacent the rear surface 40 of the emblem 18.

The EL foil 30 shown in FIG. 2 comprises one or more opaque colors 44. The opaque colors 44 are dark colors (such as black, dark blue, dark green, etc.) that are associated or used as part of the emblem 18. These opaque colors 44 may be screen printed, pad printed, painted, etc. to the EL foil 30, such as on the front surface 38. The opaque colors 44 may be printed on the foil 30 in the same process that the EL layers are printed. Because screen printing or pad printing is very rapid, several layers can be applied in rapid succession to the EL foil 30 until the colors are completely opaque. Moreover, plastic lamination 48 that is on the outside of the EL foil 30 protects the opaque colors 44 from scratches. Accordingly, the opaque colors 44 are disposed between the EL foil 30 and the lamination 48.

As shown in FIG. 2, the emblem 18 may also include one or more windows 54. The windows 54 are openings, transparent or translucent areas in the emblem 18. The position of the windows 54 is designed to correspond to and align with the position of the opaque colors 44. Thus, as the opaque colors 44 are rectangular in shape in FIG. 2, the windows 54 have a similar shape. Of course, other shapes/configurations may also be used, depending upon the shape/configuration and color scheme of the emblem 18. Accordingly, when the EL foil 30 is properly positioned, the opaque colors 44 will be visible through the windows 54. Thus, the opaque colors 44 which are part of the emblem 18, are positioned on the EL foil 30 rather than on the emblem 18 (or a portion of the emblem 18).

The EL foil 30 may also include one or more openings 60 which are positioned to align with corresponding poles 64 protruding from the rearward side 16 of cover 14. Thus, the EL foil 30 will be held in its proper position by the poles 64 engaging and/or passing through the openings 60.

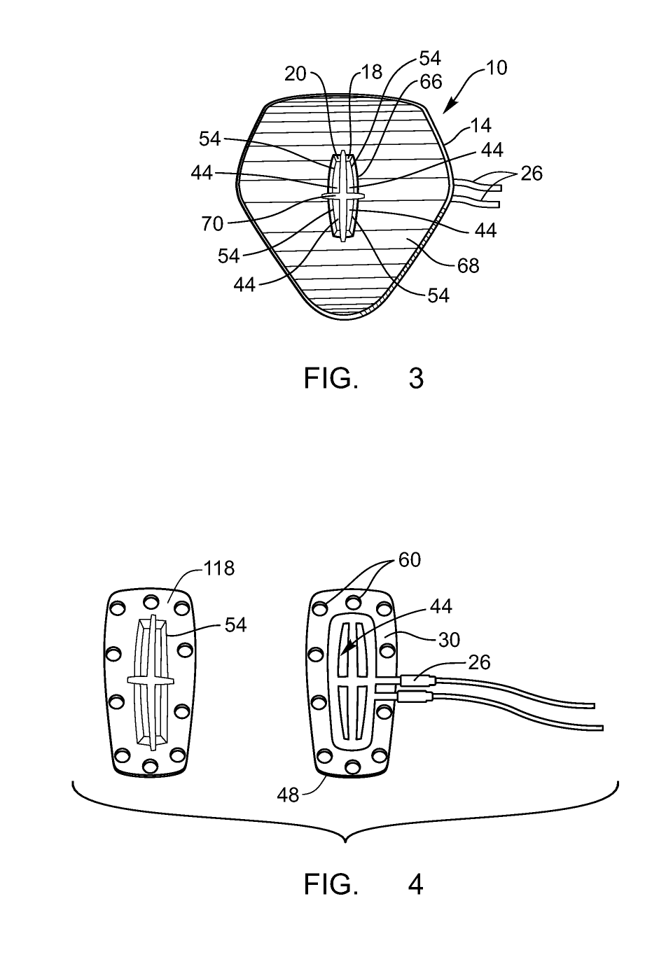

FIG. 3 shows the fully assembled apparatus 10 as it has been positioned in the airbag cover 10. As can be seen in FIG. 3, the front surface 68 of the airbag cover 14 is a class A surface that is visually appealing. The emblem 18 is designed to fit into an opening 66 in the front surface 68 of the cover 14 such that the front surface 70 of the emblem 18 is visible. Those skilled in the art will appreciate how this may be accomplished and will appreciate the variety of different methods that may be used to position or attach the emblem 18.

In the embodiment shown in FIG. 3, the emblem 18 may be a chrome emblem 20. Other materials may also be used to construct the emblem 18 as desired. In other words, the areas of the emblem 18 other than the windows 54 are all made of translucent chrome that will allow light to bleed through these areas. One or more colors may also be added to the emblem 18 as desired.

Referring now to FIGS. 1-3 collectively, it will be readily apparent that the emblem 18 positioned within the cover 14 may be illuminated (backlit) by the EL foil 30, thereby giving the emblem 18 an attractive visual appearance. Moreover, the opaque colors 44 that are associated with the emblem 18 are positioned on the EL foil 30 and are visible through windows 54 on the emblem 18. By having the opaque colors 44 on the EL foil 30, the light produced by the foil 30 will not bleed through the colors, as occurs on other backlit emblems. Moreover, this reduction of the light bleeding through the opaque colors is achieved without the requirement for multiple coats of paint or difficult painting steps. In painting, single coats of paint often look fine when added to the EL foil. Multiple coats of paint may also be used. This process also avoids the hassles of painting crevices, recesses etc. in the emblem, which are areas of the emblem that are often difficult to mask and paint properly. All such problems are obviated by the present embodiments. Likewise, there is no need for an additional component of the emblem that would contain the opaque colors, thereby reducing the cost and complexity of the emblem 18. Accordingly, significant advances may be achieved by the present embodiments.

FIG. 4 represents an additional embodiment of an emblem 118 that may be used in the apparatus 10 discussed above. For purposes of clarity, the emblem 118 is shown with EL foil 30. The front face 38 of the EL foil 30 includes the opaque colors 44 and wires 26 are added to the EL foil 30. Openings 60 are also positioned on the EL foil 30 as well as the plastic lamination 48 which shields and protects the opaque colors 44.

The emblem 118 differs from that which is shown in the other embodiments in that the emblem 118 is not made of chrome. Rather, the emblem 118 is made of a plastic material. Of course, the emblem 118 still comprises windows 54 that align with the opaque colors 44 in the manner described herein when the posts 64 engage the openings 60 for proper alignment.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An airbag apparatus comprising:
an emblem comprising one or more windows;
EL foil positioned rearward of the emblem, the EL foil capable of illuminating the emblem; and
one or more opaque colors added to the EL foil, the opaque colors being aligned with and visible through the windows.

2. An apparatus as in claim 1 wherein the opaque colors are screen printed on the EL foil.

3. An apparatus as in claim 1 further comprising plastic lamination on the outside of the EL foil, the opaque colors being disposed between the EL foil and the lamination.

4. An apparatus as in claim 1 wherein the emblem is a chrome emblem.

5. An apparatus as in claim 1 wherein the emblem is added to an airbag cover.

6. An apparatus as in claim 1 wherein the emblem comprises poles and the EL foil comprises openings, wherein the poles pass through the openings to attach the EL foil to the emblem.

7. An apparatus as in claim 1 wherein the opaque colors are added to the front surface of the EL foil.

8. A method for creating a backlit emblem on a steering wheel cover comprising:
obtaining a vehicle emblem comprising one or more windows;
obtaining EL foil that is capable of illuminating the emblem, the EL foil including one or more opaque colors;
positioning the EL foil rearward of the emblem; and
aligning the opaque colors with the windows such that the opaque colors are visible through the windows.

9. A method as in claim 1 further comprising the step of screen printing the opaque colors on the EL foil.

10. A method as in claim 1 further comprising the step of adding plastic lamination on the outside of the EL foil such that the opaque colors are disposed between the EL foil and the lamination.
